(19) United States
(12) Patent Application Publication
(10) Pub. No.: US 2019/0366962 A1
(43) Pub. Date: Dec. 5, 2019

(54) SAFETY BARRIER DEVICE AND SYSTEM AND METHODS FOR USING SAME

(71) Applicant: Glen David Moss, Thomaston, GA (US)

(72) Inventors: Glen David Moss, Thomaston, GA (US); Austin Michael Morgan, Atlanta, GA (US); Mikaela Marie Leeyi Juzswik, Atlanta, GA (US)

(21) Appl. No.: 16/411,135

(22) Filed: May 13, 2019

Related U.S. Application Data
(60) Provisional application No. 62/670,561, filed on May 11, 2018.

(51) Int. Cl. B60R 19/38; B60Q 1/50; B60R 21/34

(52) U.S. Cl. CPC B60R 19/38; B60R 2021/0067; B60R 21/34; B60Q 1/50

(57) ABSTRACT

Disclosed herein are safety barrier devices and systems for road vehicles, such as school buses and police vehicle, to simultaneously provide physical barriers and visual alerts to motors traveling nearby. In one aspect, a safety barrier device includes a deployment mechanism capable of deploying a safety barrier by extending and retracting the safety barrier from within a housing; a safety barrier connected to the deployment mechanism and comprising an elongated member with a visual alert area, and a housing for containing the deployment mechanism and safety barrier. Also disclosed herein are methods for using the disclosed devices and systems.

### CROSS REFERENCE TO RELATED APPLICATIONS

This application claims the benefit of priority to U.S. provisional patent application Ser. No. 62/670561 filed May 11, 2018, which is herein incorporated in its entirety.

### FIELD OF INVENTION

The present invention relates to safety barriers devices and system for road vehicles, such as school buses and police vehicles.

### BACKGROUND OF THE INVENTION

In some situations, it is necessary to provide a safety warning for certain types of road vehicles. For example, a school bus, police vehicle, utility vehicle or service vehicle may need to provide safety warnings for oncoming traffic. Thus, the conventional strategy is to provide a warning by using flashing lights, stop signs, and/or sirens. This often causes problems because the conventional strategy does not provide a means for preventing oncoming traffic from avoiding the area of interest.

Accordingly, there remains a need for improved safety means for preventing oncoming traffic from avoiding the area of interest. This need and other needs are satisfied by the various aspects of the present disclosure.

### SUMMARY OF THE INVENTION

In accordance with the purposes of the invention, as embodied and broadly described herein, the invention, in one aspect, relates to safety barrier devices and systems for road vehicles, such as school buses and police vehicles.

In another aspect, the invention relates to a relates to a safety barrier device for a road vehicle, such as, for example, that provides a physical barrier which gives oncoming traffic another visual aid to prevent them from running the bus stop sign and potentially harming passengers crossing the street after exiting the bus. When assisting motorist on the road, police and emergency vehicles rely on their flashing lights, yellow cones or possibly other officers or employees to caution passing motorist to slow down or prepare to stop. There is no physical barrier to encourage these actions from others drivers.

In further aspects, the disclosure provides for a safety barrier that protects children and vehicles. In still further aspects, the disclosure also relates to a method for reducing traffic related pedestrian accidents and fatalities.

In another exemplary aspect, the invention relates to a safety barrier device comprising: a) a deployment mechanism capable of deploying a safety barrier by extending and retracting the safety barrier from within a housing; b) a safety barrier connected to the deployment mechanism and comprising an elongated member with an alert area, the alert area having at least one visual element configured to produce a visual alert effective to be perceived by a nearby motorist, the deployment mechanism and safety barrier being operatively positioned and disposed relative to one another to cause movement of the safety barrier along a predetermined linear travel path in response to the deploying; and c) a housing for containing the deployment mechanism and safety barrier, the housing configured to allow extension and retraction of the safety barrier along the predetermined linear travel path from within the housing.

In yet another exemplary aspect, the invention relates to a safety barrier system for a vehicle, the system comprising: a) a disclosed safety barrier device according to the present invention; b) a controller communicatively connected to the safety barrier device and configured to control operation of the one or more device components based on instructions regarding operation of the safety barrier device; and c) a control unit communicatively connected to the controller and configured to transmit instructions regarding the operation of the safety barrier device to the controller; wherein the deployment mechanism is configured to move the safety barrier in a predefined manner while the alert area of the safety barrier is producing a visual alert to thereby alert a nearby motorist.

In still further aspects, the invention also relates to additional methods for using the disclosed devices and systems.

Additional aspects of the invention will be set forth in part in the description which follows, and in part will be obvious from the description, or can be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate several aspects of the invention and together with the description, serve to explain the principles of the invention.

FIG. 1 shows a depiction of a safety barrier device in accordance with an exemplary embodiment of the present invention.

FIG. 2 shows a depiction of a safety barrier device in accordance with an exemplary embodiment of the present invention.

FIG. 3 shows a depiction of an internal view of a safety barrier device in accordance with an exemplary embodiment of the present invention.

FIG. 4 shows a depiction of a deployment mechanism used in connection with a safety barrier device in accordance with an exemplary embodiment of the present invention.

FIG. 5 shows a depiction of a linear travel system used in a safety barrier device in accordance with an exemplary embodiment of the present invention.

FIGS. 6A-6B show depictions of a safety barrier device in accordance with an exemplary embodiment of the present invention.

FIGS. 7A-7C shows depictions of internal views of a safety barrier device in accordance with an exemplary embodiment of the present invention.

FIGS. 8A-8B shows depictions of close-up internal views of a safety barrier device in accordance with an exemplary embodiment of the present invention.

FIGS. 9A-9D shows depictions of various internal views of a safety barrier device in accordance with an exemplary embodiment of the present invention.

FIG. 10 shows a method for using the disclosed safety barrier devices and systems in accordance with another exemplary embodiment of the present invention.

FIG. 11 shows a diagram of a system including a computing device for enabling operation of the disclosed devices and systems in accordance with another exemplary embodiment of the present invention.

### DETAILED DESCRIPTION

The present invention can be understood more readily by reference to the following detailed description of the invention and the Examples included therein.

Before the present articles, systems, devices, and/or methods are disclosed and described, it is to be understood that they are not limited to specific manufacturing methods unless otherwise specified, or to particular materials unless otherwise specified, as such can, of course, vary. It is also to be understood that the terminology used herein is for the purpose of describing particular aspects only and is not intended to be limiting. Although any methods and materials similar or equivalent to those described herein can be used in the practice or testing of the present invention, example methods and materials are now described.

Moreover, it is to be understood that unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of aspects described in the specification.

All publications mentioned herein are incorporated herein by reference to disclose and describe the methods and/or materials in connection with which the publications are cited.

### A. DEFINITIONS

It is also to be understood that the terminology used herein is for the purpose of describing particular aspects only and is not intended to be limiting. As used in the specification and in the claims, the term “comprising” can include the aspects “consisting of” and “consisting essentially of” Unless defined otherwise, all technical and scientific terms used herein have the same meaning as commonly understood by one of ordinary skill in the art to which this invention belongs. In this specification and in the claims, which follow, reference will be made to a number of terms which shall be defined herein.

As used in the specification and the appended claims, the singular forms “a,” “an” and “the” include plural referents unless the context clearly dictates otherwise. Thus, for example, reference to “an element” includes two or more elements.

Ranges can be expressed herein as from one particular value, and/or to another particular value. When such a range is expressed, another aspect includes from the one particular value and/or to the other particular value. Similarly, when values are expressed as approximations, by use of the antecedent ‘about,’ it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein, the terms “about” and “at or about” mean that the amount or value in question can be the value designated some other value approximately or about the same. It is generally understood, as used herein, that it is the nominal value indicated ±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

The terms “first,” “second,” “first part,” “second part,” and the like, where used herein, do not denote any order, quantity, or importance, and are used to distinguish one element from another, unless specifically stated otherwise.

As used herein, the terms “optional” or “optionally” means that the subsequently described event or circumstance can or cannot occur, and that the description includes instances where said event or circumstance occurs and instances where it does not. For example, the phrase “optionally affixed to the surface” means that it can or cannot be fixed to a surface.

Disclosed are the components to be used to manufacture the disclosed devices and articles of the invention as well as the materials themselves to be used within the methods disclosed herein. These and other materials are disclosed herein, and it is understood that when combinations, subsets, interactions, groups, etc. of these materials are disclosed that while specific reference of each various individual and collective combinations and permutation of these materials cannot be explicitly disclosed, each is specifically contemplated and described herein. For example, if a particular material is disclosed and discussed and a number of modifications that can be made to the materials are discussed, specifically contemplated is each and every combination and permutation of the material and the modifications that are possible unless specifically indicated to the contrary. Thus, if a class of materials A, B, and C are disclosed as well as a class of materials D, E, and F and an example of a combination material, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the articles and devices of the invention. Thus, if there are a variety of additional steps that can be performed it is understood that each of these additional steps can be performed with any specific aspect or combination of aspects of the methods of the invention.

It is understood that the devices and systems disclosed herein have certain functions. Disclosed herein are certain structural requirements for performing the disclosed functions, and it is understood that there are a variety of structures that can perform the same function that are related to the disclosed structures, and that these structures will typically achieve the same result.

### B. SAFETY BARRIER DEVICES AND SYSTEMS

As briefly described above, the present disclosure relates, in various aspects, to safety barriers devices and systems for road vehicles, such as school buses, police vehicle, and emergency vehicles, and the like.

In one aspect, the present disclosure may provide a safety barrier device comprising: a) a deployment mechanism capable of deploying a safety barrier by extending and retracting the safety barrier from within a housing; b) a safety barrier connected to the deployment mechanism and comprising an elongated member with an alert area, the alert area having at least one visual element configured to produce a visual alert effective to be perceived by a nearby motorist, the deployment mechanism and safety barrier being operatively positioned and disposed relative to one another to cause movement of the safety barrier along a predetermined linear travel path in response to the deploying; and c) a housing for containing the deployment mechanism and safety barrier, the housing configured to allow extension and retraction of the safety barrier along the predetermined linear travel path from within the housing.

In another exemplary aspects, the present invention may provide a safety barrier system for a vehicle, the system comprising: a) a disclosed safety barrier device according to the present invention; b) a controller communicatively connected to the safety barrier device and configured to control operation of the one or more device components based on instructions regarding operation of the safety barrier device; and c) a control unit communicatively connected to the controller and configured to transmit instructions regarding the operation of the safety barrier device to the controller; wherein the deployment mechanism is configured to move the safety barrier in a predefined manner while the alert area of the safety barrier is producing a visual alert to thereby alert a nearby motorist.

As will be described in more detail, the safety barrier may be extended and retracted using a linear motion system comprising a deployment mechanism operatively positioned relative to a linear travel guide such that the deployment mechanism and linear travel guide cooperate to move the safety barrier along a linear travel path. To this end, the deployment mechanism may be configured to move the safety barrier in a predefined manner, for example, in a linear motion, while the safety barrier is coupled with a linear travel rail. In further aspect, the device may comprise at least one linear travel guide configured to direct travel of the safety barrier along the linear travel path. In still further aspects, the device may comprise an engagement mechanism for releasably coupling the safety barrier to the linear travel system.

In further aspects, the deployment mechanism and linear travel guide may be operatively positioned relative to one another such that the deployment mechanism and linear travel guide cooperate to move the safety barrier along the linear travel path. The linear travel guide may comprise at least one linear rail and at least one corresponding rail carriage configured to move along the at least one linear rail in the linear travel path. In still further aspects, the rail carriage may be configured to couple with the at least one linear rail to move along the at least one linear rail. The linear rail may comprise at least one stationary bar configured to attach to a corresponding aperture or slot on the rail carriage. In yet further aspects, the linear rail may comprise at least one groove configured to receive and keep a portion of the carriage rail within the groove. In even further aspects, the linear rail may comprise a first groove at a top edge and a second groove at bottom edge; and wherein the first and second groves are configured to receive and keep the carriage rail within the grooves when moving along the travel path. In various aspects, the device may utilize a linear motion system for deploying the safety barrier. In some aspects, the linear motion system may comprise a deployment mechanism and linear travel guide and/or rail. In other aspects, the linear travel system may be configured to allow a safety barrier attached to a linear travel guide to move along the linear travel path.

In further aspects, the device may comprise at least one guide wheel in mechanical communication with the safety barrier, for example, a surface of the elongated member of the safety barrier and configured to direct movement along a linear travel path. In still further aspects, the guide wheel may be configured to remain in mechanical communication with the surface of the elongated member of the safety barrier. In yet further aspects, the guide wheel may be configured to act on a different surface of the elongated member of the safety barrier than the drive wheel. The guide wheel ca be configured to act on a surface of the elongated member of the safety barrier than is opposed to the surface that the drive wheel acts on. There may be a plurality of guide wheel, which in some aspects, are not powered.

In various aspects, deploying comprises or otherwise involves extending or retracting the safety barrier from within the housing. Deploying may use linear motion, mechanical energy or the like. In further aspects, the deployment mechanism is capable of producing a linear motion. The deployment mechanism may be configured to move the safety barrier in a predefined manner along the linear travel path. In still further aspects, the deployment mechanism may be capable moving the safety barrier in a first linear direction and an opposing linear direction. In some aspects, the deployment mechanism may be capable moving the safety barrier in forward and reverse linear directions. In other aspects, the deployment mechanism may allow for conversion of continuous-direction rotary motion to linear motion. In further aspects, the deployment source may be configured to move the safety barrier in a predefined manner along a linear travel path. In still further aspects, the deployment source can comprise any desired means for producing mechanical motion or force. In some aspects, the deployment source may comprise at least one of: a motor, an actuator, screw drive, worm screw, barrel screw, wheel and axle, cam, rod, gear, track, belt, chain, rack and pinion, or the like. In other aspects, deployment source may include a drive mechanism including guide rails, gear track and/or gear motor for generating linear motion. The deployment source may employ safety barrier contact or engagement. The deployment source can allow for driving motor to spin one direction continuously to produce forward motion and the opposite direction for reverse motion using a pinion gear and drive wheel arrangement.

In further aspects, the deployment mechanism may comprise at least one of: a drivetrain, motor, screw, worm screw, barrel screw, wheel and axle, cam, rod, gear, track, belt, chain, rack and pinion, or the like. In some aspects, the deployment mechanism may comprise a DC motor driving a drive wheel, and pivoting motor assembly; wherein the drive wheel is engaged with a surface of the safety barrier, and wherein a linear spring attached to the motor assembly allows the drive wheel to pivot and remain in contact with the safety barrier. In still further aspects, a drive wheel of the deployment mechanism may remain in mechanical communication with the elongated member of the safety barrier such that substantially all the mechanical force from the deployment mechanism is transferred to the elongated member. In yet further aspects, a drive wheel of the deployment mechanism may remain in mechanical communication with a surface of the elongated member of the safety barrier such that all the mechanical force from the deployment mechanism is transferred to the elongated member.

In various aspects, the deployment mechanism may be adjustably mounted within the housing. The drive wheel of the deployment mechanism may be pivotably connected to the safety barrier using a spring-assisted connecting mechanism. In some aspects, an enclosure or bracket containing the deployment mechanism may be configured to rotate or pivot about an axis to a component or portion of the device to which it is connected. In other aspects, an enclosure or bracket holding the deployment mechanism may be configured to rotate or pivot about an axis to remain in contact with a surface or portion of the safety barrier. In further aspects, the deployment mechanism may cooperate with the at least one linear guide or rail configured to orient travel of the safety barrier along the linear travel path. In yet further aspects, the linear motion can have a travel distance of greater than 0 to about 8 feet, such as greater than 1 to about 6 feet.

In various aspects, the device may be configured to provide visual and/or audio alerts simultaneously with a physical barrier, and/or to deliver a physical barrier simultaneously with at least one visual cue that is effective to alert a nearby motorist. At least a portion of the alert area on the safety barrier may correspond to at least a portion of an outer surface of the elongated member of the safety barrier. The alert area of the safety barrier may also comprise at least one light element capable of producing and delivering illuminated alerts to the motorist and/or at least one reflective element capable of producing and delivering reflections to the motorist. In some aspects, the alert area of the safety barrier may comprise at least one visual element comprising at least one of flashing LEDs, incandescent lights, florescent lights, a LED matrix which could be programmed to display words or warnings, a digital screen, rotating mechanical reflectors, customizable reflective sing, and other attention-alerting elements. In other aspects, the at least one lighting element may comprise at least one of: light emitting diodes (LEDs), incandescent lights, florescent lights, a LED matrix which could be programmed to display words or warnings, and a digital screen. In still further aspects, the reflective element may comprise at least one of movable reflectors, rotatable reflectors, or sign with reflective characters. In even further aspects, there may be a plurality of lighting elements and/or a plurality of reflective elements. The lighting element and/or reflective element may be disposed on a surface or contained within a casing of the safety barrier.

In further aspects, the device may comprise at least one control element or controller configured to control operation of one or more device components. The controller may be communicatively connected to the device and configured to control operation of one or more device components based on instructions regarding operation of the device. In still further aspects, the device may further comprise a control unit communicatively connected to the controller and configured to transmit instructions regarding the operation of the device to the controller. In some aspects, the control unit may comprise a switch in operative communication with the device for selectively activating and/or deactivating one or more of the device components. In other aspects, the control unit may comprise a switch in operative communication with the device for selectively operating one or more of the device components. In further aspects, at least one switch may be operative communication with the device for selectively activating one or more of the device components. In still further aspects, the device may comprise at least one switch in operative communication with the device for selectively deactivating one or more of the device components. In even further aspects, there may be a plurality of switches in operative communication with the device for selectively operating the device components. Linear motion may be initiated by activating the deployment mechanism using a switch. A switch may also be configured to allow selective activation of the deployment mechanism and/or visual alert area. Still further, a switch may be configured to allow selective activation of the visual element while the safety barrier is in an extended or extending position. In some aspects, at least one of a first switch may be configured to allow selective activation of the deployment mechanism and visual alert area, a second switch may be configured to allow selective activation of the deployment mechanism and deactivation of the visual alert area, and/or a third switch may be configured to allow selective deactivation of the deployment mechanism. In other aspects, at least one of a first switch may be configured to allow selective activation of the alert area and activation of the deployment mechanism in a first direction; a second switch may be configured to allow selective activation of the deployment mechanism in a reverse direction and deactivation of the alert area; and/or a third switch may be configured to allow selective deactivation of the deployment mechanism. In yet other aspects, a switch may comprise a remote switch configured to remotely activate the deployment mechanism or alert area, or combinations thereof

In various aspects, the controller and/or devices may require a power source depending on the configuration and construction. An exemplary power source may any type of power source such as but not limited to a connection to an alternating current source (a wall plugs), a solar or other light cell, a miniature reactor, a mechanical source such as a flywheel or springs, a disposable or rechargeable battery or the like. Other power source(s) are possible. Any suitable power source may be used.

In various aspects, the controller and/or device components may be included in or integrated within various portion of the housing or casing. In further aspects, the controller and/or device components may be attached to or contained in within the housing. In still further aspects, the controller and/or device components may be contained in a housing or enclosure contained within the housing. Other locations are possible, and may depend on the size and/or other characteristics of the controller, etc. In further aspects, the device elements and/or components can be connected to an outer surface of the device casing. In still further aspects, the device elements and/or components can be connected to an inner surface of the device housing. In yet further aspects, the device elements and/or components can be integrally connected to portions of a device housing or casing. In various aspects, the device arrangement and construction of the systems can be configured to correspond to areas of the vehicles where it will be installed.

In still further aspects, the control unit may comprise a mobile device having software configured to transmit instructions regarding the operation of the device to the controller. In other aspects, the switch may comprise a wireless device configured to wirelessly activate at least one of the deployment mechanism or visual elements. A wireless switch may comprise a wireless device configured to transmit instructions regarding operation of the device. A wireless device may be operational to at least one of: present information regarding the operation of the device to a user via one or more graphic user interfaces on the wireless device, receive instructions regarding operation of the device from a user, and transmit the instructions to the device. A wireless switch may also comprise a wireless device having software configured to transmit instructions regarding operation of the device. The software may be operational to at least one of: present information regarding operation of the device to a user via one or more graphic user interfaces on the wireless device, receive instructions regarding operation of the device from a user, and transmit the instructions to the device. In further aspects, operation of the device may comprise at least one of selective activation of the deployment mechanism, selective activation of the visual element, selective deactivation of the deployment mechanism, selective deactivation of the visual element, selection of a parameter associated with the deployment mechanism, selection of a parameter associated with the visual effects produced by the visual alert area; and selection of at least one activation duration. To this end, a visual effect parameter can comprise, for example, at least one of a visual alert cycle and form of visual alert, and the like.

In various aspects, the device is configured to be mounted at predetermined height on a portion of an outer surface of a vehicle. In further aspects, the predetermined height substantially corresponds to the eye level of a motorist operating a vehicle. In contrast to the present invention, standard deployable vehicle safety devices, such as stop signs on school buses, only slightly deploy out from the vehicle, and some may extend the stop sign further into lane in hopes the sign may be more visible. In either case, the deployable stop signs are located above eye level of oncoming or passing drivers. Furthermore, deployable stop signs are never intended or no desirable to serve as physical barriers to passing motorists.

The device of the present invention on the other hand, can mount in different locations so that the visual elements are at driver's eye level. Further, since the safety barrier is lower to the ground, it creates a physical barrier which drivers cannot easily pass. To this end, the device may be configured to be mounted on any portion of an outer surface of a vehicle, for example, at a height corresponding to or near the eye level of a motorist. The device may be configured to be mounted on an outer surface of a rear portion of a vehicle, such as on a portion of an outer surface of a bumper of a vehicle. In some aspects, the device may be configured to be integrated into a bumper of a vehicle. In other aspects, the device may be configured to be mounted on a portion of an outer surface of a bumper of a vehicle. In still other aspects, the device may be configured to be mounted on a portion of an outer surface of a trunk of a vehicle. In yet other aspects, the device housing may be configured as a bumper of a vehicle.

In various aspects, a housing of the present invention can be any shape and may be in the shape of a three-dimensional polygon. In some aspects, the casing may be solid, and in other aspects, the casing may be hollow where the housing walls may define an interior space or interior sections for containing various operating elements of the invention. Any other shape (as used herein, the term shape is used in the broad sense of three-dimensional works) may be employed, so long as the shape is large enough and structured so as to be able to contain the various working components of the invention as more fully disclosed below. The housing may be manufactured from a rigid material comprising at least one of: plastic, metal, composites and combinations thereof. The housing may be dimensioned to have a length of from about 2 feet to about 10 feet, such as from about 4 feet to about 8 feet, for example, from about 5 feet to about 6 feet. The housing may have a width of from about 1 inch to about 6 inches, such as from about 2 inches to about 4 inches. The height may be from about 1 inch to about 6 inches, for example, from about 2 inches to about 4 inches.

A safety barrier according to the present invention may be dimensioned to have a length of from about 2 feet to about 9 feet, such as from about 4 feet to about 6 feet or from about 4 feet to about 5 feet. The safety barrier width may be from 0.1 inch to about 4 inches, such as from about 1 inch to about 2 inches. The safety barrier height may be from about 0.1 inch to about 4 inches, such as from about 1 inch to about 2 inches. Elongated members used to construct the safety barrier may be flat or in the shape of a three-dimensional polygon, such as a tubular or cylinder shape. Any other shape (as used herein, the term shape is used in the broad sense of three-dimensional works) may be employed, so long as the shape is structured so as to be able support the visual elements and methods of using the invention as more fully disclosed below. In further aspects, the device may be comprised of any desired material, such as, and without limitation, cast metal (e.g., aluminum).

In further aspects, the device may further comprise on opening through a wall or outer surface of a housing or safety barrier body for providing an amplifier that is connected to the controller or a sound element contained within the housing. In still further aspects, the device may comprise an opening through the outer surface for providing a light, such as an LED light, that is connected to the controller or a timing element contained within the housing. A light (and/or sound) may be turned on when linear motion or movement is initiated and turned off when power to the device element is turned off or signal is turned down. Alternatively, powering on the device may also power on a timing element, and optionally a light (and/or sound), so that when a desired time period has occurred, the timing element may turn off the light (and/or sound), or may turn off a light (and/or sound) and the deployment mechanism, or the timing element or controller may turn on sound or light after a period of operation. Alternatively, the timing element may be under a control that is separate from a control for the deployment mechanism. Components for switches, controller, such as a polycarbonate circuit board and the programming to accomplish the disclosed activities and others, and elements such as timing elements, sound elements and light elements, are known, and can be selected or commercially acquired by those of skill in the art. Wires for connecting the elements within the devices or on the surface are contemplated by the present invention.

In further aspects the device may comprise at least one connecting mechanism comprising a pivot point, hinge, joint, ball joint, fitting, insert, adhesive, brazing, soldering, welding, spot weld, screw with nut, rivet, threading, friction fit, snap-fit, twist-lock, or interlocking mechanism or a combination thereof. The device may also comprise at least one engagement means or securing means for coupling and holding device components together. The engagement means can be a screwing mechanism, a click-lock mechanism, or friction mechanism, a clasp, clip, pin, fastener, snap, closure, or the like.

According to various aspects of the disclosure, the devices and systems of the present invention provides a number of advantages over current options. Without wishing to be bound by a particular theory, the combination of inventive configurations, device construction and positioning allow the disclosed devices and systems to be effective in preventing pedestrian-motor vehicle accident. In further aspects, the disclosed devices and systems provide a physical barrier with visual alert which deploys into oncoming traffic to prevent vehicles from injuring pedestrians. In further aspects, the present disclosure may prevent passengers, workers, and police officers from injury. In still further aspects, the present disclosure may provide for added safety for mass transit devices. In even further aspects, the present disclosure may provide for added safety for utility vehicles, emergency vehicles, construction vehicles, and specialized vehicles. In still further aspects, the present disclosure provides a physical barrier to obstruct illegal passing, and means for deterring illegal passing of buses or other vehicles. In another aspect, the present disclosure provides a safety barrier that protects emergency crews, police officers, fire fighters, ambulance workers, construction crews, government workers, and military soldiers. In further aspects, the present disclosure provides for one or more visual cues and/or audio cues that alert surrounding traffic, passersby and pedestrians to slow down and/or be aware of safety. In yet further aspects, the present disclosure can provide an additional safety means to be used in conjunction with other safety measures to protect pedestrians. Such safety measures include but are not limited to stop signs, flashing lights, sirens, safety arms, crossing guards and the like.

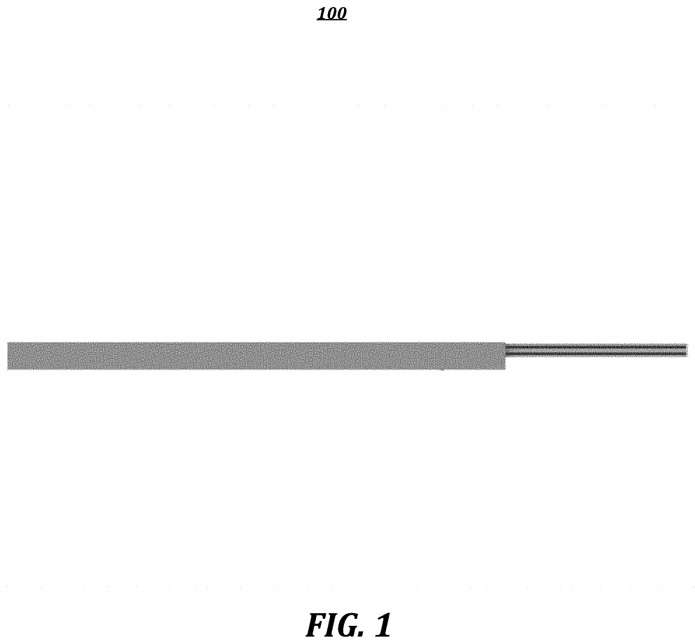

According to various aspects of the invention, the devices, methods, and systems of the present disclosure can comprise multiple configurations. FIGS. 1-11 show depictions and perspectives of exemplary embodiments of devices, methods and systems in accordance with the present invention. In one embodiment, a safety barrier device of the present invention can comprise a housing, an extendable safety barrier, flashing lights and other visual alerts or cues. In another embodiment, the safety barrier device can further comprise one or more of: a friction system, a drivetrain, a linear motion system, a drive wheel, a linear actuator, a motor, a linear spring, a pivot, a rail carriage, and a linear rail.

The flashing lights and other visual alerts or cues may be attached to or otherwise integrated within the extendable safety barrier body or casing. The safety barrier device may comprise a mechanism to deploy the extendable safety barrier. The safety barrier may be configured such that it may be extended into the driving lane of oncoming traffic. The safety barrier device may comprise at least one linear rail and at least one friction driven wheel. The linear rail and friction driven wheel may be used as a mechanism to deploy the extending safety barrier. Other mechanisms may be used for deployment of the barrier including but not limited to: a rack and pinion, piston, and pulley mechanism.

In some embodiments, the components of the safety barrier device include a housing, an extendable safety barrier, and a deployment mechanism. A housing may be provided such that the housing protects the barrier, drive mechanism, electronics and other components from road debris, weather, and other potentially harmful elements. The housing may also serve as a mounting point for all components. The housing may also provide a solid platform to mount to the vehicle. The safety barrier may be configured to extend into an immediate left lane of traffic relative to the road vehicle to alert and obstruct drivers from driving through this lane. The safety barrier may deter illegal passing. The barrier may be provided for increasing the safety of passengers. The safety barrier may also provide a platform for one or more visual cues to be applied, affixed or attached. The one or more visual cues may include but is not limited to flashing lights or other visual elements. The one or more visual elements or cues can be mounted to the safety barrier surface to further alert and deter motorists from passing.

A deployment mechanism may be provided such that the deployment mechanism may be used to effectively extend and retract the safety barrier into the oncoming lane of traffic. The deployment mechanism may be configured such that deployment happens at variable speeds such that the safety barrier may be extended quickly, safely and reliably. The deployment mechanism may also function as a retraction mechanism. The deployment mechanism may be configured such that the same assembly performs both the function of extension of the safety barrier and retraction of the safety barrier.

In another embodiment, the function of the retraction of the safety barrier may be performed by a separate assembly. This separate assembly may be a retraction mechanism. This retraction mechanism may be contained within another enclosure within the housing and configured to act on a different segment of the safety barrier relative to extension. In some embodiments, the retraction mechanism may contain one or more of a motor, a rack and pinion, a piston, a pulley mechanism, a friction-based wheel drive, a loading actuator, a spring, a pivot, and the like. The retraction mechanism may contain at least one of a separately powered assembly and a motor. The retraction mechanism may also function utilizing the same components of the deployment mechanism.

In various embodiments, the device components, including but not limited to the housing, safety barrier, and deployment mechanism may be constructed or comprise various materials including but not limited to one or more of aluminum, steel, plastic, metal rods, steel beams, rubber, foam, composite materials and the like. In some embodiments, the safety barrier may comprise an aluminum tube. In other embodiments, the safety member may comprise a flat, elongated member. The tube or member may be mounted to a linear rail. The linear rail may be mounted to the housing. A wheel with sufficient traction to engage with the safety barrier may be pressed by a spring against the safety barrier. A motor may rotate the wheel in order to extend or retract the safety barrier depending on the direction of rotation. The extension and retraction of the barrier may be controlled by one or more switches, buttons, or controls. The one or more switches, buttons, or controls maybe accessible by a user including but not limited to a bus driver or vehicle operator.

The safety barrier may comprise at least one internally mounted limit switch. The safety barrier may be extended until an internally mounted limit switch is triggered, signifying the fully extended position of the safety barrier. Upon or prior to full extension, flashing lights and/or one or more visual cues that been mounted to the safety barrier surface may be activated to alert drivers in the area. A switch may be configured such that when the switch may be used to deploy the barrier, the switch may be returned to the off position. The switch may remain in an off position once the barrier retracts until it hits another limit switch signaling the full retraction position of the safety barrier at which point the motor may be turned off or the signal being sent is decreased to cause the motor to turn off. The one or more visual elements or cues may also be configured be turned off in coordination.

In other embodiments, the manner in which the safety barrier may be deployed could be changed. For example, rather than use of a friction-based wheel drive, other linear actuators could be used to extend the barrier. The shape of the safety barrier could also change. For example, rather than having a long rigid aluminum tube barrier, a variety of materials including but not limited to a plastic bar, telescoping metal or plastic tubes, a piston, a fold out mechanism, or inflatable safety barrier could be used along with a broad range of other materials and forms. The form of lights or visual cues on the barrier could also change. For example, the safety barrier device could use, but not be limited, to flashing LEDs, incandescent lights, florescent lights, a large LED matrix which could be programmed to display words or warnings, a digital screen, rotating mechanical reflectors, and other possible attention alerting mechanisms could be used. The housing can also change. Rather than aluminum U-channel, a variety of materials including but not limited to an injection molded plastic, cast materials, formed materials or any number of alternatives could be used for a housing.

In still other embodiments, the safety barrier device may comprise a friction drive system. The safety barrier device may comprise a specific linear actuator. The safety barrier device may comprise one or more general linear actuators. Further, the safety barrier system may be configured such that the housing and linear rail systems could be combined into one part. The safety barrier device may be configured such that additional features may be provided to capture the attention of surrounding persons including but not limited to sirens, sounds, bells, whistles, varying audio cues and visual cues. Equipment enabling the use of these additional features could be added to the housing and the safety barrier.

In yet other embodiments, the safety barrier device may be configured such that the safety barrier and deployment mechanism comprise a robust frame. The robust frame may be provided such that the safety barrier could be shielded from elements. In such a configuration, a housing may not be necessary. As such a housing could be left out entirely and components could bolt to a frame which could attach to the bus or other vehicle. The safety barrier device may be configured such that the linear rail may be able to hold the load of the extended safety barrier. Furthermore, the mounts from the linear rail to the housing and the housing itself may be able configured to hold these loads.

It should be understood that a variety of materials and components may be used to construct and enable the present disclosure. The materials may be able to perform the task of extending and retracting the barrier. The absence of one or more materials may not prevent the disclosure from being enabled. There are no components that MUST be made of certain materials. The electrical components may be provided such that standard electronic and electrical components are used to operate the disclosure. For example, wires may be made of a conductive material and resistors of the appropriate resistive material.

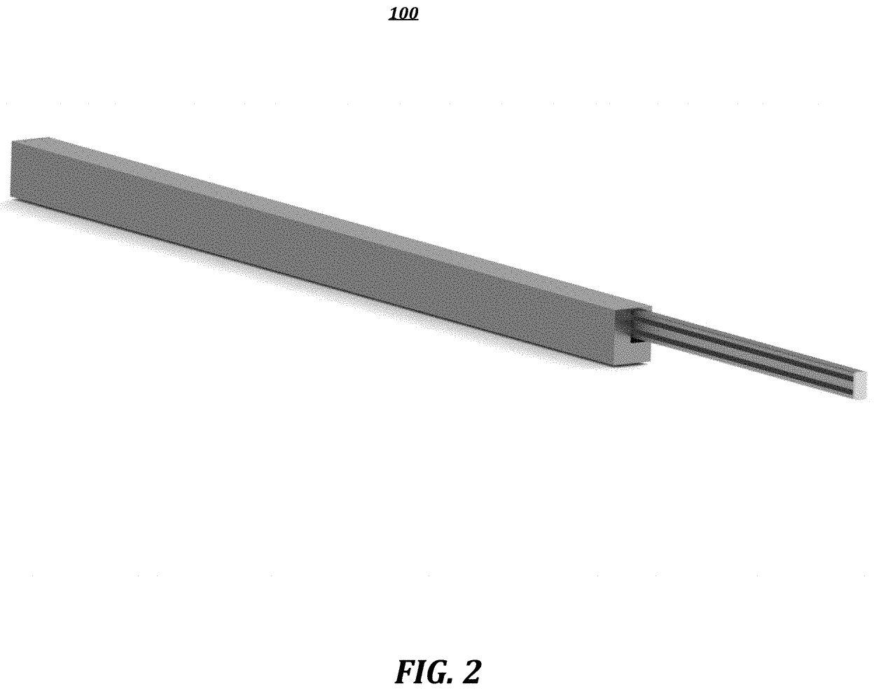

FIGS. 1-5 show an exemplary embodiment of safety barrier device 100 for a road vehicle. FIGS. 1-2 show safety barrier device 100 including extendable safety barrier 102 retractably mounted within housing 104. Safety barrier 104 is in the extended position. As shown, safety barrier 104 comprises an alert area 106 with a plurality of visual elements 108 in the form of LED arrays. Housing 104 is a U-channel aluminum extrusion housing having aluminum front and side covers. Safety barrier 104 comprises tube that acts as a physical barrier with a flashing waterproof LEDs on the outer surface that acts a visual cue and for alerting oncoming traffic.

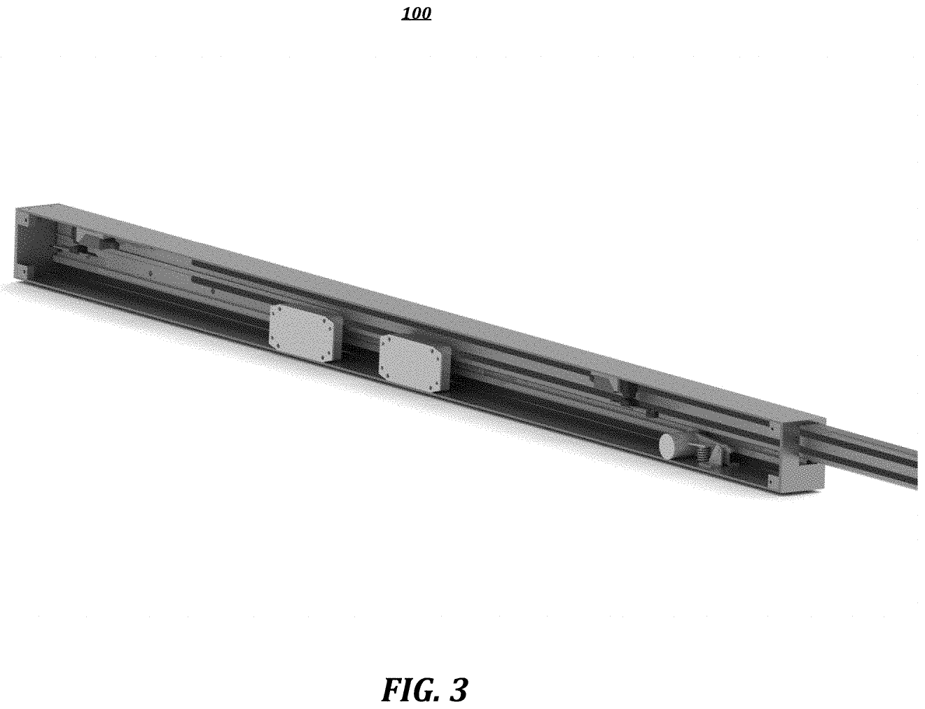

FIG. 3 shows the internal overview of safety barrier device 100, including deployment mechanism 110 comprising a drivetrain capable of deploying a safety barrier by extending and retracting the safety barrier from within a housing. Housing 100 further contains linear travel guide 112 configured to direct travel of the safety barrier along the linear travel path. The deployment mechanism and linear travel guide are operatively positioned relative to one another such that the deployment mechanism and linear travel guide cooperate to move the safety barrier along the linear travel path. The device also includes two limit switches 124 which are configured to selectively activate/deactivate the deployment mechanism and/or LEDs. Also show are waterproof enclosures 126 for housing device electronics such as a controller.

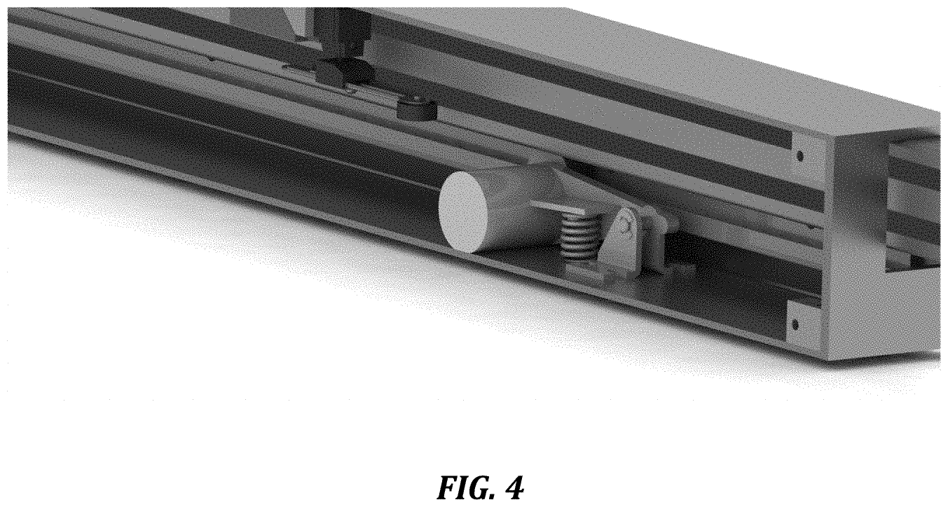

FIG. 4 shows deployment mechanism 110 drivetrain comprising a DC motor driving 114 a drive wheel 116, pivot 118 for motor assembly, mounting bracket 120, and linear spring 122. As shown, the drive wheel is configured to engage with the bottom surface of the safety barrier, and the linear spring attached to the motor assembly allows the drive wheel to pivot and remain in contact with the safety barrier. As shown, the deployment mechanism allows for conversion of continuous-direction rotary motion to linear motion, and is capable moving the safety barrier in forward and reverse linear directions.

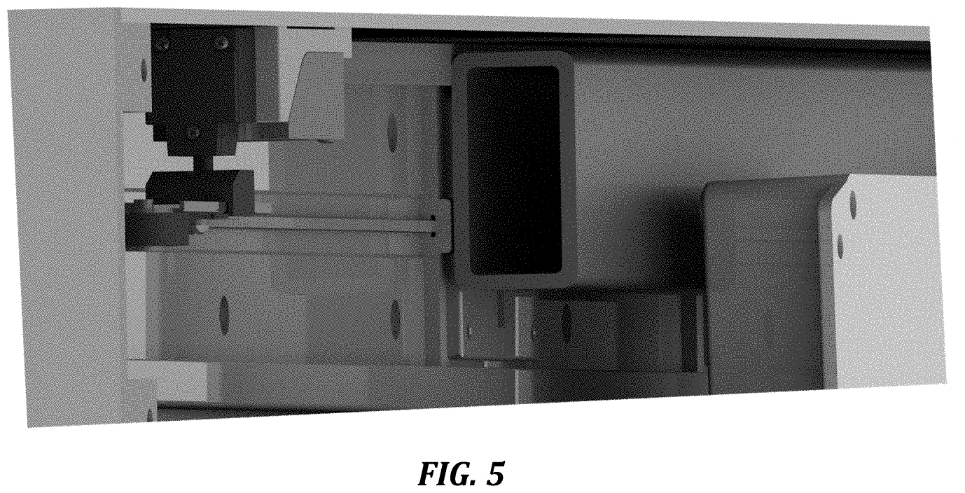

FIG. 5 shows an exemplary linear motion system 130 used in safety barrier device 100. Linear motion system 130 generally comprises a deployment mechanism and linear travel guide 112, which includes linear rail 132 and corresponding rail carriage 134 which moves along the linear rail in the linear travel path. Linear rail 132 has one stationary bar in the middle that is configured to attach to a corresponding aperture or slot in the rail carriage; a first groove at a top edge and a second groove at bottom edge; and the first and second groves are configured to receive and keep the carriage rail within the grooves when moving along the travel path. As shown, safety barrier 102 is attached to rail carriage which is coupled with linear travel rail to move the safety barrier along the linear travel path.

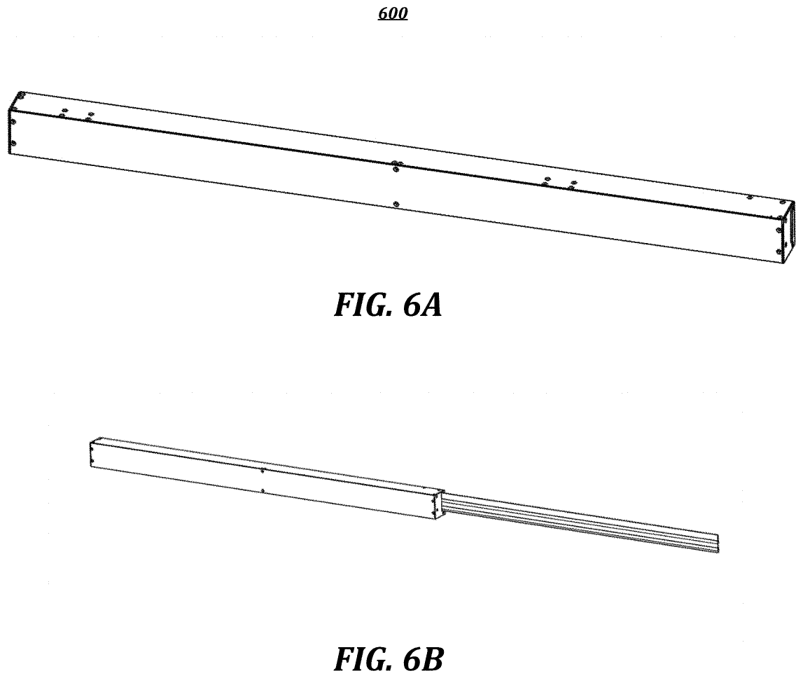

FIGS. 6A-9D show another exemplary embodiment of safety barrier device 600 for a road vehicle. FIGS. 6A-6B show safety barrier device 600 including extendable safety barrier 602 retractably mounted within housing 604. Safety barrier 604 is shown in the retracted position in FIG. 6A and in the extended position in 6B. As shown, safety barrier 604 comprises an alert area 606 with a plurality of visual elements 608 in the form of LED strips. Housing 604 is a U-channel aluminum extrusion housing having bolt-on aluminum front and side covers. In this embodiment, safety barrier 604 comprises a flat member that also serves as a physical barrier with a flashing waterproof LEDs on the outer surface that acts a visual cue and for alerting oncoming traffic.

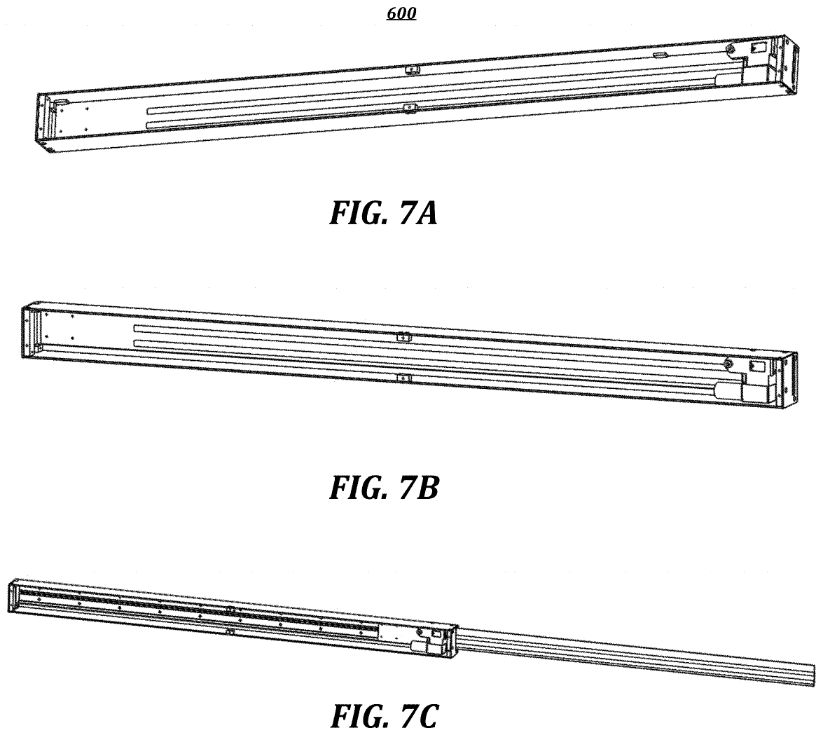

FIGS. 7A-7C show the internal overview of safety barrier device 600, including deployment mechanism 610 comprising a drivetrain capable of deploying safety barrier by extending and retracting safety barrier from within a housing through housing slot and the end. Housing 600 further contains linear travel guide 612 configured to direct travel of safety barrier back and forth along a linear travel path. Deployment mechanism and linear travel guide are operatively positioned relative to one another such that the deployment mechanism and linear travel guide cooperate to move the safety barrier along the linear travel path. Limit switches may also be included at opposed ends for selectively activating/deactivating the deployment mechanism and/or LEDs.

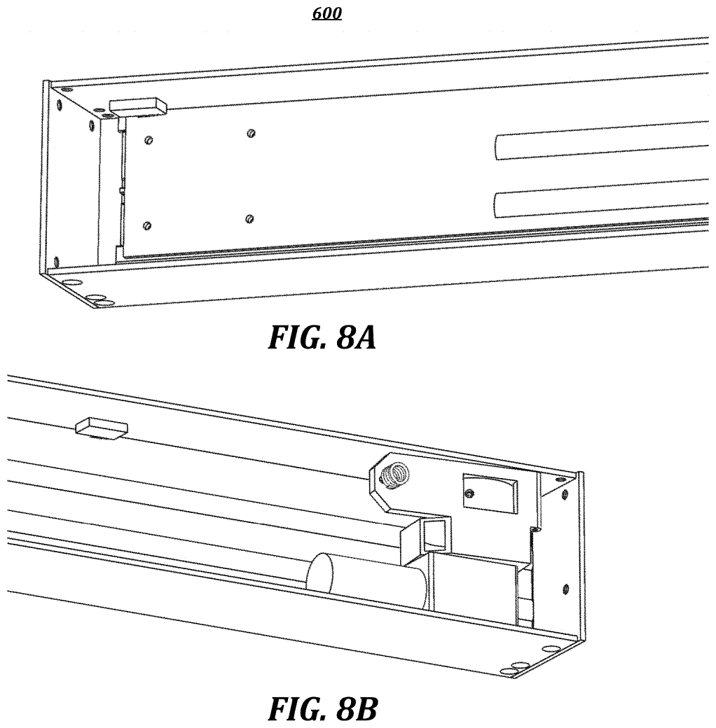

FIG. 8A shows linear travel guide 612 and FIG. 8B shows deployment mechanism 610 drivetrain comprising pivoting motor assembly, a DC motor driving 614 a drive wheel 616, mounting bracket 620, and linear spring 622. As shown, the drive wheel is configured to engage with the front surface the safety barrier adjacent to LEDS. Linear spring attached to the motor assembly allows the drive wheel to pivot and remain in contact with the safety barrier surface. Deployment mechanism allows for conversion of continuous-direction rotary motion to linear motion, and is capable moving the safety barrier in forward and reverse linear directions.

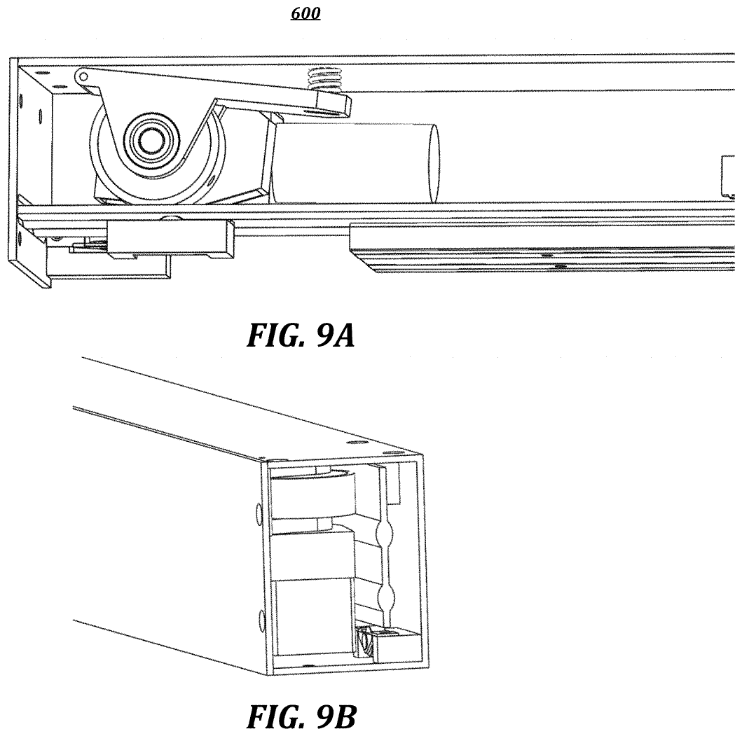

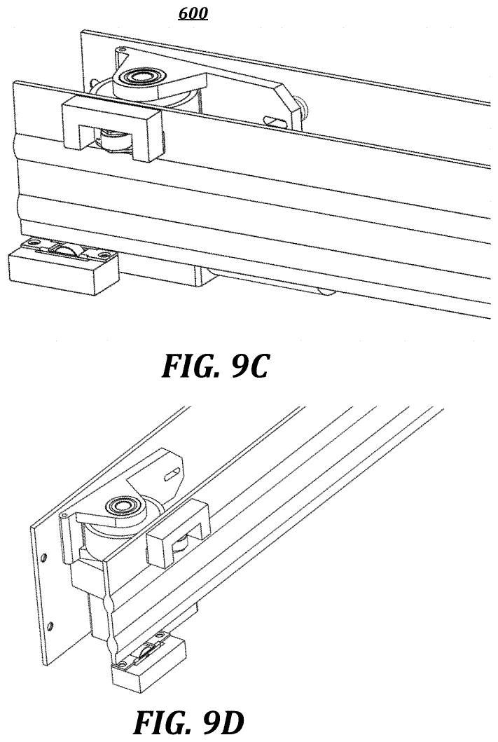

FIGS. 9A-9D show another exemplary linear motion system 630 used in safety barrier device 600. Linear motion system 630 comprises deployment mechanism 610, linear travel guide 612, and guide wheels 636. linear travel guide 612 includes linear rail 632 and corresponding rail carriage 634 which moves along the linear rail in the linear travel path. As shown, guide wheels 636 are mechanical communication with a surface of the elongated member of safety barrier 604 and direct movement along the travel path. Guide wheels are configured to remain in mechanical communication with the surface of the elongated member of the safety barrier, and engage a different surface of the elongated member of the safety barrier than the drive wheel, such as the bottom surface and surface opposed to that the drive wheel acts on. Linear rail 632 has one stationary bar in the middle that is configured to attach to a corresponding aperture or slot in the rail carriage; a first groove at a top edge and a second groove at bottom edge; and the first and second groves are configured to receive and keep the carriage rail within the grooves when moving along the travel path. As shown, safety barrier 102 is attached to rail carriage which is coupled with linear travel rail to move the safety barrier along the linear travel path.

Also disclosed herein are methods of using the disclosed devices and systems. For example, in another exemplary aspect, the present disclosure provides a method for a method for deploying a safety barrier during a bus stop treating damaged skin, fascia and muscle tissue in a subject using a disclosed device or system. In further aspects, the disclosed safety barrier devices and systems can be used for school buses and other mass transit vehicles. The disclosure could potentially be used by police departments, utility companies, first responders or other similar companies.

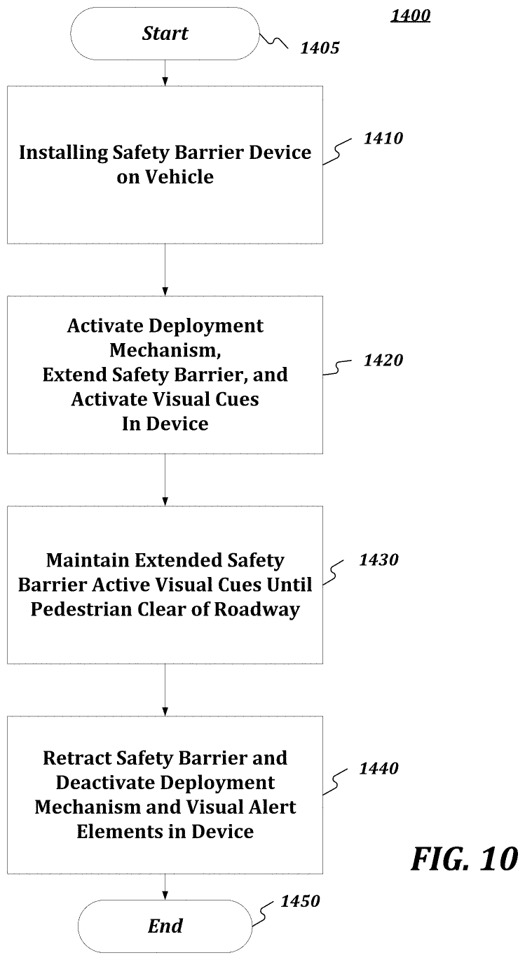

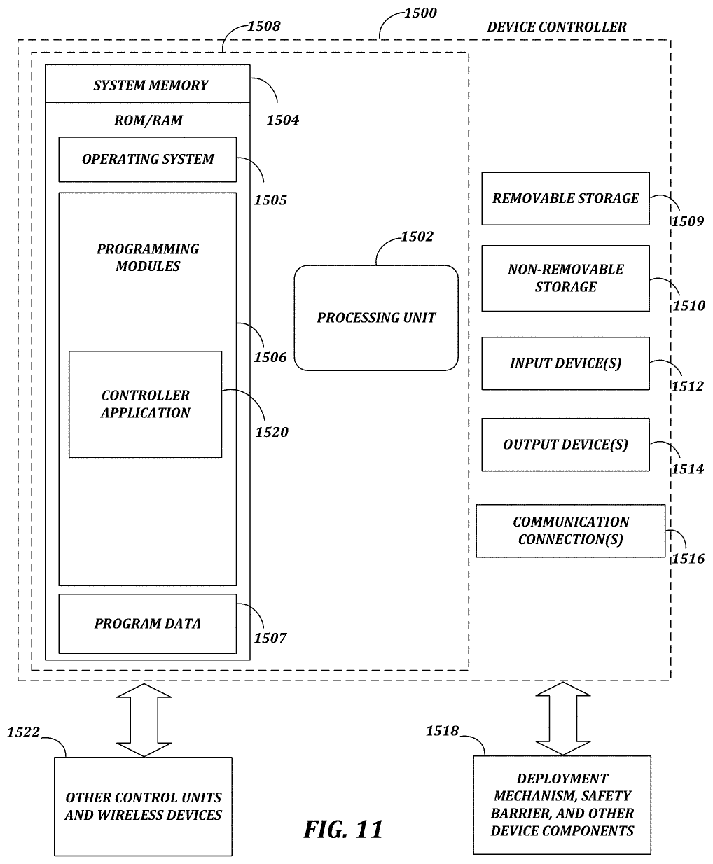

In further aspects, FIG. 10 is a flow chart setting forth the general stages involved in a method 1400 consistent with an embodiment of the disclosure for operating the disclosed safety barrier devices and systems. Method 1400 may be implemented using device 100 or 600 described in FIGS. 1-9D, and, at least in part, a controller 1500 (e.g., microcontroller or on-board computing device) as described in more detail below with respect to FIG. 11. Controller 1500 may comprise a controller for operating the devices and device components as well as well as performing other operational tasks, including, but not limited to, linear motion control and parameters, and communication. As such, controller 1500 may be in operative configuration and communication with, for example, but not be limited to, motors, visual elements, activating and/or limit switches, communication module, power source, power regulator, various telemetry sensors, transceivers and antennas. As will be detailed with reference to FIG. 11, controller 1500 may comprise a remote communication module to enable remotely operation as described herein. In other embodiments, controller 1500 may be completely self-operating upon configuration.

Furthermore, although stages are disclosed with reference to device 100 or controller 1500, it should be understood that a plurality of other components may enable the operation of method 1400, including, but not limited to, other computing components, mechanical components (e.g., sensors or switches), environment properties (e.g., proximity), user conditions, and the like. Further still, although the stages illustrated by the flow charts are disclosed in a particular order, it should be understood that the order is disclosed for illustrative purposes only. Stages may be combined, separated, reordered, and various intermediary stages may exist. Accordingly, it should be understood that the various stages illustrated within the flow chart may be, in various embodiments, performed in arrangements that differ from the ones illustrated. Moreover, various stages may be added or removed from the flow charts without altering or deterring from the fundamental scope of the depicted methods and systems disclosed herein.

Method 1400 may begin at starting block 1405 and proceed to stage 1410, where the device may be installed on or mounted to a surface of a vehicle. From stage 1410, where the device is positioned on the vehicle, method 1400 may proceed to stage 1420 where the safety barrier device and/or components may be activated. The activation of device components, though disclosed in a particular order for illustrative purposes, may occur in other arrangements. Upon activation, deployment mechanism may begin to deploy safety barrier. In still further aspects, a user may activate or de-activate (and/or otherwise control operation of) the disclosed devices by using a control unit, such as a wireless device or mobile device that is in operative communication with the disclosed device. The wireless device may be a device that may be used for additional purposes other than use with the invention such as a mobile phone, tablet computer, notebook computer, desktop computer, etc. In an embodiment, the invention may provide a specialized wireless device for use with the invention. The specialized wireless device may include other uses if its use is not limited to this particular embodiment of the invention. As provided in more detail herein, the control unit used to control the devices may include an application or application software (an “app”) specifically created for such usage. Advantageously, the user may download and/or otherwise obtain the app from sources that supply apps such as independent developers and app stores. The app as used with embodiments of the invention communicates wirelessly, such as by using Bluetooth or the like technology.

Controller 1500 (e.g., microcontroller or on-board computing-device) may automatically activate device elements instantly or after a set amount of time has passed since the launch. In other embodiments, activation may occur upon certain reading from on-board sensors (e.g., including, but not limited to, sensors deployed in the casing, housing and/or frame assembly). For example, activation of deployment mechanism may be dependent on certain factors and/or user conditions such as, for example, open/closed status of the bus door, speed, acceleration, and the like. Controller 1500 may be configured to trigger activation of device components upon the satisfaction of certain pre-set conditions. Such conditions may be defined prior to activation.

From stage 1420, where the device components are activated, method 1400 may proceed to stage 1430, where the device will extend the safety barrier out and deliver visual cues or effects for a time sufficient to allow face pedestrian passage. From stage 1430, where the device is used to provide a physical barrier and visual alerts to nearby motorists, method 1400 may proceed to stage 1440, where the device components are turned off, wherein the safety barrier is retracted and the visual alert area is deactivated. After stage 1440, method 1400 may end at stage 1450. During all stages, the devices may be in operable communication with the user via wired or wireless communication component. The user may receive various readings from the various device components. In some embodiments, the user may control the operation of the devices during use. For example, the user may be able to control the device components, including, but not limited to, retractable safety barrier, visual elements, lighting elements, activating switch, communication module, power source, power regulator, various telemetry sensors, transceivers and antennas. In other embodiments, controller 1500 may be pre-configured with operational control instructions and/or data.

In various aspects, the disclosed devices and systems may comprise, but not be limited to, an integrated controller and/or on-board computing module. The computing module may be in operative configuration and communication with, for example, but not be limited to, the deployment mechanism, visual elements, activating switch, communication module, power source, power regulator, various sensors, transceivers and antennas. Further, the computing module may be in operative communication with another computing device consistent with the description herein, and may comprise, but not be limited to, a wireless device, smart phone, desktop computer, laptop, a tablet, or mobile telecommunications device. Such remote devices may be used to control and/or configure integrated computing module (e.g., activation conditions, safety barrier operating parameters and settings, and the like). Moreover, the devices may be in operative communication with a centralized server, such as, for example, a cloud computing service. Although operation has been described to be performed, in part, by a controller 1500, it should be understood that, in some embodiments, different operations may be performed by different networked elements in operative communication with controller 1500.

Embodiments of the present disclosure may comprise a system having a memory storage and a processing unit. The processing unit may be coupled to the memory storage, wherein the processing unit is configured to perform the stages of method 1400. FIG. 11 is a block diagram of a system including controller 1500. Consistent with an embodiment of the disclosure, the aforementioned memory storage and processing unit may be implemented in a computing device, such as controller 1500. Any suitable combination of hardware, software, or firmware may be used to implement the memory storage and processing unit. For example, the memory storage and processing unit may be implemented with controller 1500 or any of devices and components 1518, or any other control unit and wireless devices 1522, in combination with controller 1500. Other devices and components 1518 may comprise, for example, but not be limited to, control or deployment mechanisms, visual elements, lighting elements, activating switch, communication module, power source, power regulator, various sensors, transceivers and antennas. The aforementioned system, device, and processors are examples and other systems, devices, and processors may comprise the aforementioned memory storage and processing unit, consistent with embodiments of the disclosure.

With reference to FIG. 11, a system consistent with an embodiment of the disclosure may include a computing device, such as controller 1500. In a basic configuration, controller 1500 may include at least one processing unit 1502 and a system memory 1504. Depending on the configuration and type of computing device, system memory 1504 may comprise, but is not limited to, volatile (e.g. random-access memory (RAM)), non-volatile (e.g. read-only memory (ROM)), flash memory, or any combination. System memory 1504 may include operating system 1505, one or more programming modules 1506, and may include a program data 1507. Operating system 1505, for example, may be suitable for controlling controller 1500's operation. In one embodiment, programming modules 1506 may include a controller application (“app”) 1520. Furthermore, embodiments of the disclosure may be practiced in conjunction with a graphics library, other operating systems, or any other application program and is not limited to any particular application or system. This basic configuration is illustrated in FIG. 11 by those components within a dashed line 1508.

Advantageously, the app may provide a user with information as well as be the user's interface to operating the embodiment of the invention. The app may include one or more graphic user interfaces (GUIs). Among the GUIs of the app may be a GUI allowing the user to pick which, if there is more than one, reciprocating and/or thermal elements to activate, and to select (if available) one or more operating parameters or characteristics (such as strength or frequency) of the reciprocating mechanical forces of the head attachment(s). The user may be able to adjust such selections without having to deactivate the embodiment from a GUI of the app. The user may also use the app to turn on and turn off the device components. Another advantage of the app is that the app may present the user with a GUI that depicts the user's body (or a generic body) and shows where the forces are being applied. The GUI may include additional or other information relating to the forces being applied such as the strength or frequency. The additional or other information may be color coded and/or otherwise presented so as to be readily understood by the user by looking at the GUI of the app. The app may also present the user with information received from the device components, such as environmental and telemetry data.

Controller 1500 may have additional features or functionality. For example, controller 1500 may also include additional data storage devices (removable and/or non-removable) such as, for example, magnetic disks, optical disks, or tape. Such additional storage is illustrated in FIG. 11 by a removable storage 1509 and a non-removable storage 1510. Computer storage media may include volatile and nonvolatile, removable and non-removable media implemented in any method or technology for storage of information, such as computer readable instructions, data structures, program modules, or other data. System memory 1504, removable storage 1509, and non-removable storage 1510 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by controller 1500. Any such computer storage media may be part of device 1500. Controller 1500 may also be operative with input device(s) 1512 such as a keyboard, a mouse, a pen, a sound input device, a touch input device, etc. Input device(s) 1512 may be used to, for example, manually access and program controller 1500. Output device(s) 1514 such as a display, speakers, a printer, etc. may also be included. The aforementioned devices are examples and others may be used.

Controller 1500 may also contain a communication connection 1516 that may allow device 1500 to communicate with other control units and wireless devices 1522 as well as devices and other components 1518 (e.g., deployment mechanism, transceivers, sensors, lighting elements), such as over an encrypted network in a distributed computing environment. Communication connection 1516 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, Bluetooth™, radio frequency (RF), infrared, and other wireless media. The term computer readable media as used herein may include both storage media and communication media.

As stated above, a number of program modules and data files may be stored in system memory 1504, including operating system 1505. While executing on processing unit 1502, programming modules 1506 (e.g., controller application 1520) may perform processes including, for example, one or more of stages or portions of stages of method 1400 as described above. App 1520 may be configured to operate device components 1518 and receive instructions from, for example, communications connections module 1516. The aforementioned process is an example, and processing unit 1502 may perform other processes.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, multiprocessor systems, microprocessor-based or programmable consumer electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

While aspects of the present invention can be described and claimed in a particular statutory class, such as the system statutory class, this is for convenience only and one of skill in the art will understand that each aspect of the present invention can be described and claimed in any statutory class. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way appreciably intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

Throughout this application, various publications are referenced. The disclosures of these publications in their entireties are hereby incorporated by reference into this application in order to more fully describe the state of the art to which this pertains. The references disclosed are also individually and specifically incorporated by reference herein for the material contained in them that is discussed in the sentence in which the reference is relied upon. Nothing herein is to be construed as an admission that the present invention is not entitled to antedate such publication by virtue of prior invention. Further, the dates of publication provided herein can be different from the actual publication dates, which can require independent confirmation.

The patentable scope of the invention is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A safety barrier device for a vehicle, the device comprising:
a) a deployment mechanism capable of deploying a safety barrier by extending and retracting the safety barrier from within a housing;
b) a safety barrier connected to the deployment mechanism and comprising an elongated member with an alert area, the alert area having at least one visual element configured to produce a visual alert effective to be perceived by a nearby motorist, the deployment mechanism and safety barrier being operatively positioned and disposed relative to one another to cause movement of the safety barrier along a predetermined linear travel path in response to the deploying; and
c) a housing for containing the deployment mechanism and safety barrier, the housing configured to allow extension and retraction of the safety barrier along the predetermined linear travel path from within the housing.

2.-93. (canceled)

94. The device of claim 1, further comprising at least one linear travel guide configured to direct travel of the safety barrier along the linear travel path.

95. The device of claim 94, wherein the device comprises an engagement mechanism for releasably coupling the safety barrier to the linear travel guide.

96. The device of claim 95, wherein the deployment mechanism and linear travel guide are operatively positioned relative to one another such that the deployment mechanism and linear travel guide cooperate to move the safety barrier along the linear travel path.

97. The device of claim 96, wherein the linear travel guide comprises at least one linear rail and at least one corresponding rail carriage configured to move along the at least one linear rail in the linear travel path.

98. The device of claim 97, wherein the at least one rail carriage is configured to couple with the at least one linear rail to move along the at least one linear rail.

99. The device of claim 98, wherein the at least one linear rail comprises at least one stationary bar configured to attach to a corresponding aperture or slot on the rail carriage and at least one groove configured to receive and keep a portion of the carriage rail within the groove.

100. The device of claim 98, wherein the at least one linear rail comprises a first groove at a top edge and a second groove at bottom edge; and
wherein the first and second groves are configured to receive and keep the carriage rail within the grooves when moving along the travel path.

101. The device of claim 99, wherein the deployment mechanism and linear guide comprise a linear motion system, the device comprising a linear travel system configured to allow a safety barrier attached to a linear travel guide to move along the linear travel path.

102. The device of claim 101, further comprising a guide wheel in mechanical communication with a surface of the elongated member of the safety barrier and configured to direct movement along the travel path; wherein the guide wheel is configured to remain in mechanical communication with the surface of the elongated member of the safety barrier.

103. The device of claim 102, wherein the guide wheel is configured to act on a different surface of the elongated member of the safety barrier than the drive wheel.

104. The device of claim 103, wherein the deployment mechanism comprises a DC motor driving a drive wheel, and pivoting motor assembly; wherein the drive wheel is engaged with a surface of the safety barrier, and wherein a linear spring attached to the motor assembly allows the drive wheel to pivot and remain in contact with the safety barrier.

105. The device of claim 104, wherein the drive wheel of the deployment mechanism remains in mechanical communication with the elongated member of the safety barrier such that substantially all the mechanical force from the deployment mechanism is transferred to the elongated member.

106. The device of claim 104, wherein the drive wheel of the deployment mechanism remains in mechanical communication with a surface of the elongated member of the safety barrier such that all the mechanical force from the deployment mechanism is transferred to the elongated member.

107. The device of claim 104, wherein the alert area of the safety barrier comprises one or more of: at least one light element capable of producing and delivering illuminated alerts to the motorist or at least one reflective element capable of producing and delivering reflections to the motorist.

108. The device of claim 104, wherein the device is configured to be mounted at predetermined height on a portion of an outer surface of a vehicle; wherein the predetermined height substantially corresponds to the eye level of a motorist operating a vehicle.

109. A safety barrier system for a vehicle, the system comprising:
a) a safety barrier device comprising:
a deployment mechanism capable of deploying a safety barrier by extending and retracting the safety barrier from within a housing;
a safety barrier connected to the deployment mechanism and comprising an elongated member with an alert area, the alert area having at least one visual element configured to produce a visual alert effective to be perceived by a nearby motorist, the deployment mechanism and safety barrier being operatively positioned and disposed relative to one another to cause movement of the safety barrier along a predetermined linear travel path in response to the deploying; and
a housing for containing the deployment mechanism and safety barrier, the housing configured to allow extension and retraction of the safety barrier along the predetermined linear travel path from within the housing;
b) a controller communicatively connected to the safety barrier device and configured to control operation of the one or more device components based on instructions regarding operation of the safety barrier device; and
c) a control unit communicatively connected to the controller and configured to transmit instructions regarding the operation of the safety barrier device to the controller;
wherein the deployment mechanism is configured to move the safety barrier in a predefined manner while the alert area of the safety barrier is producing a visual alert to thereby alert a nearby motorist; and
wherein the deployment mechanism and linear travel guide are operatively positioned relative to one another such that the deployment mechanism and linear travel guide cooperate to move the safety barrier along the linear travel path.

110. The system of claim 109, further comprising at least one linear travel guide configured to direct travel of the safety barrier along the linear travel path, and an engagement mechanism for releasably coupling the safety barrier to the linear travel system.

111. The system of claim 110, wherein the deployment mechanism and linear travel guide are operatively positioned relative to one another such that the deployment mechanism and linear travel guide cooperate to move the safety barrier along the linear travel path.

112. The system of claim 111, further comprising a guide wheel in mechanical communication with a surface of the elongated member of the safety barrier and configured to direct movement along the travel path; wherein the guide wheel is configured to remain in mechanical communication with the surface of the elongated member of the safety barrier.

113. The system of claim 112, wherein operation of the device comprises at least one of selective activation of the deployment mechanism, selective activation of the visual element, selective deactivation of the deployment mechanism, selective deactivation of the visual element, selection of a parameter associated with the deployment mechanism, selection of a parameter associated with the visual effects produced by the visual alert area; and selection of at least one activation duration.
